(19) United States
(12) Patent Application Publication
(10) Pub. No.: US 2004/0062164 A1
(43) Pub. Date: Apr. 1, 2004

(54) Optical storage apparatus and abnormality detection method of detector for emission control

(75) Inventors: Shinji Miyamoto, Kawasaki (JP); Yuji Karakawa, Kawasaki (JP); Toru Ikeda, Kawasaki (JP); Takashi Masaki, Kawasaki (JP); Masatsugu Nishida, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/664,224

(22) Filed: Sep. 17, 2003

(30) Foreign Application Priority Data
Sep. 30, 2002 (JP) 2002-284766

(51) Int. Cl. G11B 7/125

(52) U.S. Cl. 369/53.26

(57) ABSTRACT

An apparatus automatically controls the laser power of the light source by the feedback output of the APC detector and prevents the increase of laser power due to an abnormality of the APC detector. The automatic power control unit controls the drive amount of the light source by the detection output of the APC detector, which monitors the emission power of the light source, measures the relationship between the APC drive instruction amount and the detection output of the APC detector, and compares this inclination with the inclination at normal time. Also the automatic power control unit compares the error values before and after APC, and detects the change of the quantity of returned light during a predetermined period. As a result, data destruction due to separation, deviation, contamination or deterioration of the APC detector can be prevented effectively.

### BACKGROUND OF THE INVENTION

1. Field of the Invention

The present invention relates to an optical storage apparatus which records and regenerates information to/from a storage medium, and an abnormality detection method of a detector for emission control.

2. Description of the Related Art

Advancement of technology in the information recording field is remarkable, and research and development of optical memories utilizing light, such as magneto-optical disk memories, optical disks and optical cards, is actively progressing. In such an optical storage apparatus, a laser diode is often used as the light source, and automatic power control (APC) is used to make the emission power on the medium constant.

FIG. 14 is a block diagram depicting the APC of a conventional optical storage apparatus. As FIG. 14 shows, the light emitted from the semiconductor laser element (laser diode) 110 passes through the optical system (such as convex lens 100, beam splitter 111, rising mirror 140), is then converged by the objective lens 116, and is irradiated onto the recording medium (disk) 4.

The reflected light from the recording medium 4 returns via the originally transmitted path, is reflected by the beam splitter 111, and is received by the detector (photoelectric conversion element) 120 via the Wollaston prism 126 and condensing lens 121. The servo/MO regeneration section 160 regenerates the regeneration signal MO, track error signal TES, and focus error signal FES from the output of the detector 120, as is already known.

Using the track error signal and focus error signal, track servo and focus servo control are performed so that the optical beam follows up the track of the recording medium, and follows up to the focused point.

Now the APC (Auto Power Control) mechanism, which is a general laser driving method, will be described. The APC detector 113 monitors emitting light from the beam splitter 111. The output of the APC detector 113 is converted into detection voltage by the I-V (current-voltage) conversion circuit 114, and then is compared with the reference voltage REF, which is output from the main controller (MPU) 180, by the comparator 153. This reference voltage changes according to the optical power as required, for example, depending on the read power, erase power and write power.

The difference output from the comparator 153 is input to the driver circuit 155 via the gain amplifier 154, and drives the laser diode 110. By this, a predetermined amount of emission can be constantly obtained from the laser diode 110.

As FIG. 16 shows, the optical disk apparatus records data by allowing the laser diode 110 to emit at a high-write power onto the medium. The read power, on the other hand, is set to a power lower than the write power/erase power in order to read the data of the medium.

If this read power increases up to a level closer to erase power and write power, the data on the medium may be erased during reading. This problem is especially conspicuous in the case of an overwrite medium.

To prevent such a state, the target power (reference voltage) that is set by the controller 180 is determined by monitoring the quantity of light contacting the APC detector 113. Since the band of the I-V (current-voltage) conversion circuit 114 is low, the write power and erase power, to emit at short intervals, cannot always execute the APC operation.

Therefore the target power value is decided by measuring the relationship of the current to flow into the laser diode (DAC instruction value, in this case) vs. the power on the objective lens (detection output of the APC detector) in advance, as shown in FIG. 15, since the ratio of the detection output of the APC detector and the power on the objective lens is constant. The threshold value and the inclination of this relationship change, depending on the characteristics and temperature of an individual apparatus. Therefore conventionally, when an arbitrary time and temperature changes, an emission adjustment operation is performed where the current value and power are measured for two or more points, and the relational expression thereof is determined to calculate the current value for setting the target power (e.g. see Japanese Patent publication No. 3,060,698 (pages 8 to 10, FIG. 5 and FIG. 6)).

Such emission adjustment can appropriately sets the emission power. However, this is based on the assumption that the APC detector 113 is accurately monitoring the emission power of the laser diode 110.

The APC detector 113 is mounted on the optical head base (mechanism), and there is the possibility that separation, deviation, contamination or deterioration will occur to the APC detector. If separation, deviation, contamination or deterioration occurs due to applications in mobile usage, a drop in the price of optical disk drives, and a decrease in the power consumption of optical disk drives which are now being seen, then the relationship between the quantity of light contacting the APC detector and optical power on the objective lens may be changed, and a power greater than the power being set by the controller may be emitted onto the medium, which may erase data on the medium.

### SUMMARY OF THE INVENTION

With the foregoing in view, it is an object of the present invention to provide an optical storage apparatus and an abnormality detection method of a detector for emission control for detecting the change in the relationship between the quantity of light contacting the APC detector and optical power on the objective lens, and preventing data destruction in advance.

It is another object of the present invention to provide an optical storage apparatus and an abnormality detection method of a detector for emission control for detecting the abnormality of the APC detector before a read/write operation, and preventing data destruction in advance.

It is still another object of the present invention to provide an optical storage apparatus and an abnormality detection method of a detector for emission control for detecting the separation and deviation of the APC detector, and preventing data destruction in advance.

To achieve this object, the present invention is an optical storage apparatus for writing and reading a storage medium using a laser beam, including a light source for emitting a laser beam onto the storage medium, a servo control section for performing follow up control of the laser beam to the storage medium according to a reflected light from the storage medium, an APC detector for monitoring the emission power of the light source, and a control unit for calculating a drive instruction amount which follows the detection output of the APC detector, and performs automatic power control of the light source according to the drive instruction amount, so that the emission power on the storage medium is maintained to be a write power during the writing, and the emission power on the storage medium is maintained to be a read power during the reading. And the control unit measures the inclination of the relationship between the drive instruction amount and the detection output of the APC detector, and judges the abnormality of the APC detector by comparing the pre-measured inclination of the relationship between the drive instruction amount and the detection output of the APC detector with the measured inclination.

The abnormality detection method of the present invention includes a step of performing automatic power control of the light source which emits a laser beam for writing and reading a storage medium onto the storage medium according to the drive instruction amount calculated based on the detection output of an APC detector for monitoring the emission power of the light source, so that the emission power on the storage medium is maintained to be a write power during the writing, and the emission power on the storage medium is maintained to be a read power during the reading, a step of measuring the inclination of the relationship between the drive instruction amount and the detection output of the APC detector, and a step of judging the abnormality of the APC detector by comparing the pre-measured inclination of the relationship between the drive instruction amount and the detection output of the APC detector, and the above mentioned measured inclination.

According to the present invention, the inclination of the relationship between the APC drive instruction amount and the detection output of the APC detector is measured and compared with the reference inclination.

So a large change of inclination at measurement time can be regarded as an abnormality of the APC detector, not as a fluctuation by temperature change, and can be identified as separation, deviation, deterioration or contamination of the APC detector.

Also according to the present invention, it is preferable that the control unit measures the detection output of the APC detector when the light source is driven with the drive instruction amount, and measures the inclination of the relationship between the drive instruction amount and the detection output of the APC detector. Therefore an abnormality of the APC detector can be detected during emission adjustment.

Also according to the present invention, it is preferable that the inclination of the relationship between the drive instruction amount and the detection output of the APC detector is measured when loading the storage medium. By this, an abnormality of the APC detector can be detected in advance before read/write.

Also according to the present invention, it is preferable that the control unit judges the abnormality of the APC detector by comparing a value obtained by dividing the detected inclination by the pre-measured inclination with the threshold value. Therefore the present invention can be widely applied to light sources and apparatus which have various inclination characteristics.

Also according to the present invention, it is preferable that the control unit performs the automatic power control with an arbitrary time interval, and measures the inclination of the relationship between the drive instruction amount and the detection output of the APC detector from the drive instruction amount at the start of automatic power control. Therefore an abnormality of the APC detector can be detected even when APC is operating.

Further, the present invention is an optical storage apparatus for writing and reading a storage medium using a laser beam, including a light source for emitting a laser beam onto the storage medium, a servo control unit for performing follow up control of the laser beam to the storage medium following the reflected light from the storage medium, an APC detector for monitoring the emission power of the light source, and a control unit for calculating the drive instruction amount which follows the error between the detection output of the APC detector and the reference value, and performs automatic power control of the light source according to the drive instruction amount so that the emission power on the storage medium is maintained to be a write power during the writing, and the emission power on the storage medium is maintained to be a read power during the reading. And the control unit performs the automatic power control with an arbitrary time interval, and also judges the abnormality of the APC detector by measuring the error values for a plurality of times and comparing the error values measured for the plurality of times in a state with said drive instruction amount fixed.

Also, an abnormality detection method of the present invention includes a control step of performing automatic power control of a light source which emits a laser beam for writing and reading a storage medium onto the storage medium according to the drive instruction amount calculated based on the error between the detection output of an APC detector for monitoring the emission power of the light source and the reference value, so that the emission power on the storage medium is maintained to be a write power during the writing, and the emission power on the storage medium is maintained to be a read power during the reading, a step of performing the automatic power control with an arbitrary time interval and measuring the error values for a plurality of times in a state with the drive instruction amount fixed, and a step of judging the abnormality of the APC detector by comparing the error values measured for the plurality of times.

In this mode, error values are compared during APC processing, so the abnormality of the APC detector can be judged before increasing the power of the storage medium.

Furthermore, the present invention is also an optical storage apparatus for writing and reading a storage medium using a laser beam, including a light source for emitting a laser beam onto the storage medium, a servo control unit for detecting reflected light from the storage medium and performing follow up control of the laser beam to the storage medium, an APC detector for monitoring the emission power of the light source, and a control unit for calculating the drive instruction amount which follows the detection output of the APC detector and performs automatic power control of the light source according to the drive instruction amount, so that the emission power on the storage medium is maintained to be a write power during the writing, and the emission power on the storage medium is maintained to be a read power during the reading. And the control unit measures the average value of the quantity of the reflected light during a predetermined period, and judges the abnormality of the APC detector by comparing the average value of the measured quantity of the reflected light with the pre-measured average value of the quantity of the reflected light.

An abnormality detection method of a detector for emission control according to the other form of the present invention includes a control step of performing automatic power control of a light source which emits a laser beam for writing and reading a storage medium onto the storage medium according to the drive instruction amount calculated based on the detection output of an APC detector for monitoring the emission power of the light source, so that the emission power on the storage medium is maintained to be a write power during the writing, and the emission power on the storage medium is maintained to be a read power during the reading, a step of measuring the average value of the quantity of the reflected light from the storage medium during a predetermined period, and a step of judging the abnormality of the APC detector by comparing the average value of the measured quantity of the reflected light with the average value of the quantity of the pre-measured reflected light.

In this mode, the change of the quantity of the returned light during a predetermined period is measured, so the abnormality of the APC detector can be easily judged in a state where the APC loop is set.

### BRIEF DESCRIPTION OF THE DRAWINGS

FIG. 1 is a block diagram depicting the optical storage apparatus according to an embodiment of the present invention;

FIG. 2 is a front view depicting the APC detector in FIG. 1;

FIG. 3 is an A-A cross-sectional view of FIG. 2;

FIG. 4 is a block diagram depicting the LD controller in FIG. 1;

FIG. 5 is a diagram depicting the DAC output level of the LD controller in FIG. 4;

FIG. 6 is a flow chart depicting the APC processing in FIG. 4;

FIG. 7 is a flow chart depicting the reference value measurement processing according to the first embodiment of the present invention;

FIG. 8 is a flow chart depicting the abnormality judgment processing according to the first embodiment of the present invention;

FIG. 9 is a diagram depicting the detection operation according to the first embodiment of the present invention;

FIG. 10 is a flow chart depicting the reference value measurement processing according to the second embodiment of the present invention;

FIG. 11 is a flow chart depicting the abnormality judgment processing according to the second embodiment of the present invention;

FIG. 12 is a flow chart depicting the abnormality judgment processing-according to the third embodiment of the present invention;

FIG. 13 is a flow chart depicting the abnormality judgment processing according to the fourth embodiment of the present invention;

FIG. 14 is a diagram depicting a conventional APC control section;

FIG. 15 is a diagram depicting the relationship between the APC drive value and the power of the objective lens; and

FIG. 16 is a diagram depicting conventional read, erase and write power.

### DESCRIPTION OF THE PREFERRED EMBODIMENTS

Embodiments of the present invention will now be described in the sequence of optical storage apparatus, APC control processing, abnormality detection processing of APC detector, and other embodiments, however the present invention is not limited to these embodiments.

[Optical Storage Apparatus]

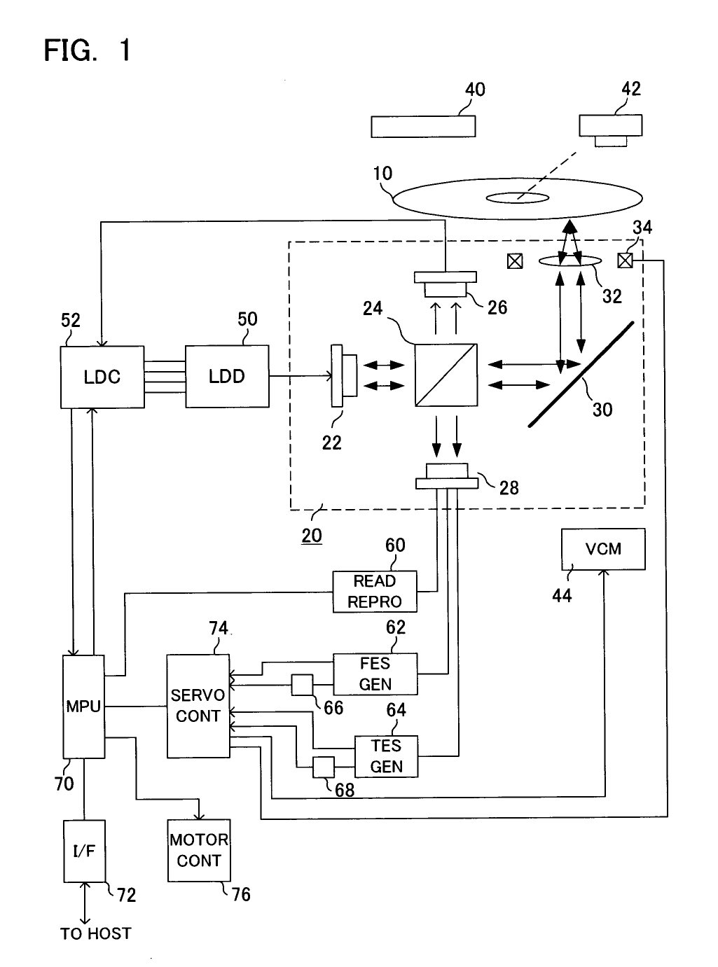

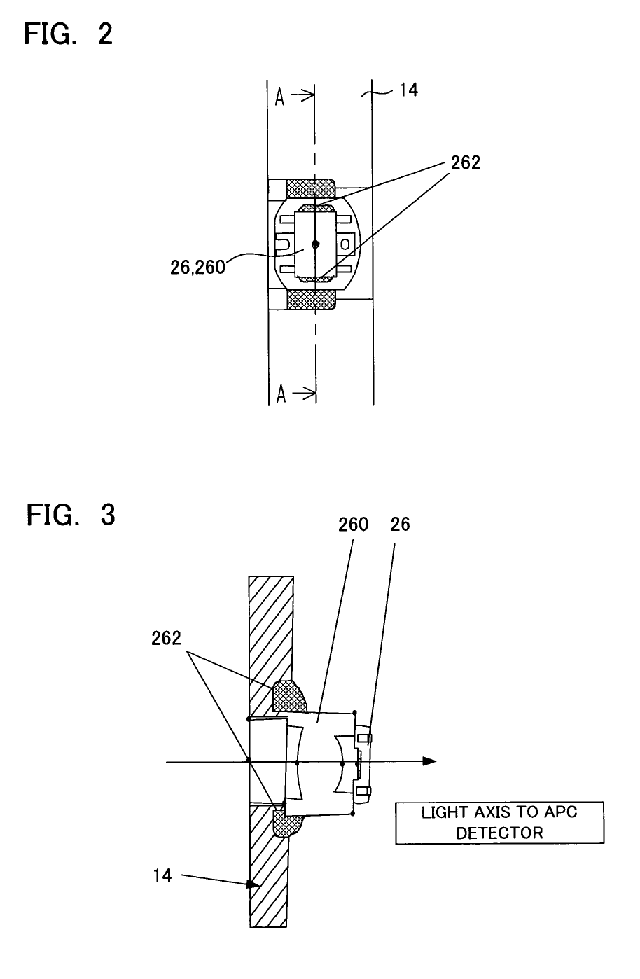

FIG. 1 is a block diagram depicting an entire optical disk drive according to an embodiment of the present invention, FIG. 2 is a front view of the APC detector in FIG. 1, and FIG. 3 is an A-A cross-sectional view in FIG. 2.

In FIG. 1, a magneto-optical drive will be described using an optical magnetic drive, where a magneto-optical disk is used as the recording medium as an example.

As FIG. 1 shows, the spindle motor 42 rotates the optical information recording medium (MO disk) 10. Normally MO disk 10 is a removable medium, and is inserted into a drive slot, which is not illustrated. The optical pickup 20 is positioned facing the magnetic field application coil 40, sandwiching the optical information recording medium 10.

The optical pickup 20, which is moved by the track actuator (voice coil motor: VCM) 44, can access an arbitrary position in a radius direction of the optical information recording medium 10.

The optical head (optical pickup) 20 will now be described. The diffused light from the laser diode 22 is guided to the optical recording medium 10 side via the beam splitter 24, is changed to parallel light by the collimator lens (not illustrated), is reflected by the rising mirror 30, then is condensed almost to the limit of diffraction onto the optical information recording medium 10 by the objective lens 32. The optical head 20 may be a separated type optical system where the objective lens 32 constitutes a movable optical system, and laser diode 22 and the detector constitute a fixed optical system.

A part of light which enters the beam splitter 24 is reflected by the beam splitter 24, and is condensed to the APC (Auto Power Control) detector 26 via the condensing lens, which will be described later with reference to FIG. 2 and FIG. 3.

The light reflected by the optical information recording medium 10 is again reflected by the mirror 30 via the objective lens 32, and then reenters the beam splitter 24. A part of the light which reenters the beam splitter 24 returns to the laser diode 22, and the rest of the light is reflected by the beam splitter 24, and is condensed onto the reflected light detector 28 via the three-beam Wollaston prism and a cylindrical lens, which are not illustrated.

Since the incident light has three beams, the reflected light detector 28 is comprised of a four-division detector, MO signal detectors which are disposed at the top and bottom thereof, and detectors for track error detection which are disposed at the left and right thereof.

The regeneration signal, which is obtained from each detector of the reflected light detector 28, will now be described. As FIG. 1 shows, the FES (Focus Error Signal) generation circuit 62 performs focus error detection (FES) based on a known astigmatism method, using the photoelectric-converted outputs A, B, C and D of the four-division photo-detector. In other words, FES=(A+B)−(C+D)/A+B+C+D). At the same time, the TES generation circuit 64, based on the push-pull method, performs track error detection (TES) by the following computing equation using outputs E and F of the track detection detector.

TES=(E−F)/(E+F)

The focus error signal (FES) and the track error signal (TES), determined by these calculations, are input to the servo controller 74 as the focus direction and the track direction position error signals.

The off focus detection circuit 66 slices the amplitude of the focus error signal FES with a predetermined off focus slice, and outputs the off focus signal. And the off track detection circuit 68 slices the amplitude of the track error signal TES with a predetermined off track slice, and outputs the off track signal.

Recorded information on the MO disk 10 is detected as follows. The polarization characteristic of the reflected light, which changes depending on the direction of the magnetization of the magneto-optical recording layer on the optical information recording medium 10, is converted into light intensity. That is, the reflected light from the beam splitter 24 is separated into two beams, where the polarization directions are perpendicular to each other by polarization detection in the above mentioned three-beam Wollaston prism, which is not illustrated, and two beams enter the two-division photo-detector of the reflected light detector 28 through the cylindrical lens, and are photo-electrically converted respectively.

The two electric signals G and H, after photo-electrical conversion by the two-division photo-detector, are subtracted by the read regeneration circuit 60, and become the read (MO) signal (RAM=G−H), which is output to the main controller (MPU) 70.

The reflected light from the semiconductor laser diode 22, which entered the photo-detector for APC 26, is photo-electrically converted and input to the LD controller 52. As mentioned later with reference to FIG. 2, the LD controller 52 compares the reference value of each mode (read, write, erase), which is instructed by the main controller 70, with the photo-electric conversion value, calculates the error value, and outputs it to the main controller 70. The APC control voltage is output to the LD drive 50 from the main controller 70.

The LD drive 50 converts the APC control voltage into DC drive current, and drives the laser diode 22.

The servo controller 74, to which the focus error signal (FES) from the FES generation circuit 62 and the track error signal (TES) from the TES generation circuit 64 are input, performs a known focus servo control, and drives the focus actuator 34 which drives the objective lens 32 of the optical head 20 in the focus direction. In the same way, the servo controller 74 performs track servo control according to the track error signal (TES), and drives the track actuator (VCM) 44.

The motor controller 76 performs rotation control of the spindle motor 42. The interface circuit 72 performs interface control between the main controller 70 and the external host.

The main controller 70 outputs the reference value of the emission power, APC control value and write data to the LD controller 52 according to each mode (read, write, erase).

FIG. 2 and FIG. 3 are diagrams depicting the mounting of the above mentioned photo-detector for APC 26, where FIG. 2 is a front view and FIG. 3 is an A-A cross-sectional view of FIG. 2. As FIG. 2 and FIG. 3 show, the APC detector 26 is mounted on the condensing lens 260 (block). The condensing lens 260 is bonded to the mechanism base 14 of the optical head 20 by adhesive 262 at two locations.

The optical axis of the APC detector 26 is installed so as to match the reflected optical axis of the beam splitter Therefore if the optical axis of the APC detector 26 deviates from the one at installation, the light receiving quantity of the APC detector 26 changes, and the relationship between the output of the APC detector.26 and the emission power of the objective lens changes. The deviation of the optical axis in this configuration is caused by the separation of adhesive 262 due to deterioration over time. Also the APC detector 26 is integrated with the condensing lens 260, so the light receiving quantity of the APC detector 26 changes, and the relationship between the output of the APC detector 26 and the emission power of the objective lens changes due to the contamination of the condensing lens and the deterioration of the detector itself, and the relationship between the output of the APC detector 26 and the emission power of the objective lens changes.

In the present invention, a drop in APC functions due to a performance drop in the APC detector is detected, and data destruction is prevented in advance.

[APC Control Processing]

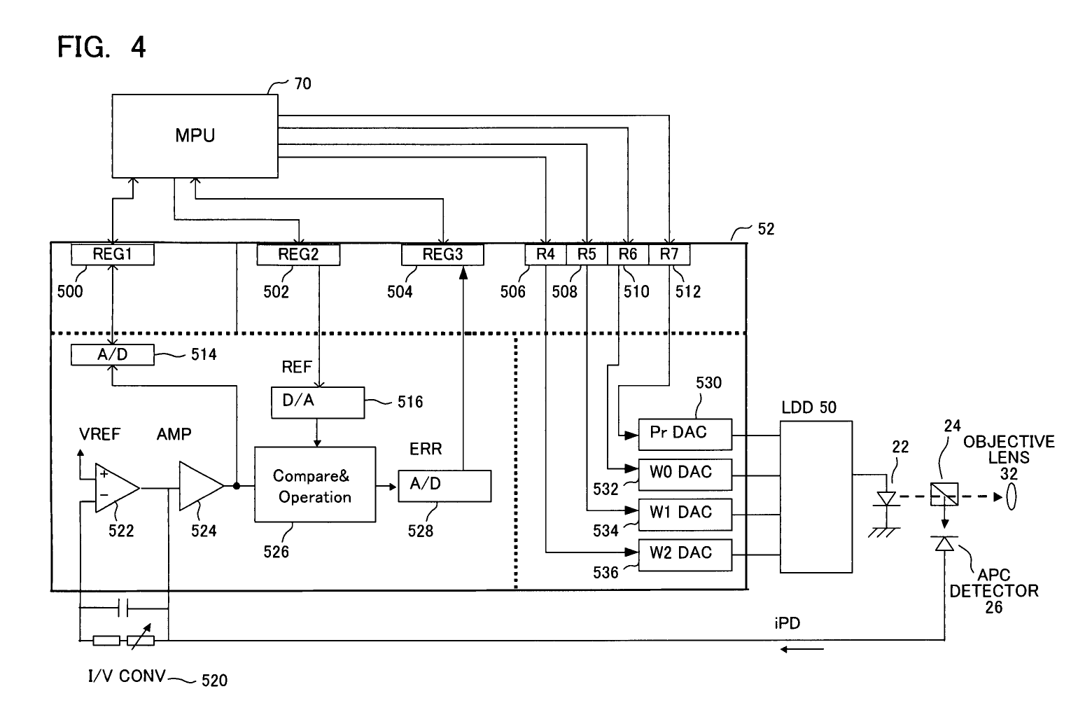

FIG. 4 is a detailed circuit diagram of the LD controller 52 in FIG. 1. In FIG. 4, the same composing elements as FIG. 1 to FIG. 3 are denoted with the same reference numbers. The I-V conversion circuit 520 converts the detection current iPD according to the light receiving quantity from the APC detector 26 into voltage. In this example, the resistance and differential amplifier 522 constitute the I-V conversion circuit 520.

The amplifier 524 amplifies the converted voltage. This amplified voltage is converted into a digital value by the A/D (Analog/Digital) conversion circuit 514, and then is stored to the register 500. The MPU (main controller) 70 can read the register 500.

The D/A (Digital/Analog) converter 516 converts the reference value REF of each mode of read/erase/write, which is set in the register 502 by the MPU 70, into analog. The comparator 526 compares the measured voltage from the amplifier 524, and the reference voltage, which has been converted into analog, and calculates the error amount ERR. This error amount ERR is converted into a digital value by the A/D (Analog/Digital) conversion circuit 528, and is then stored to the register 504. The MPU (Main Controller) 70 reads the register 504, and calculates the APC control value, as mentioned later.

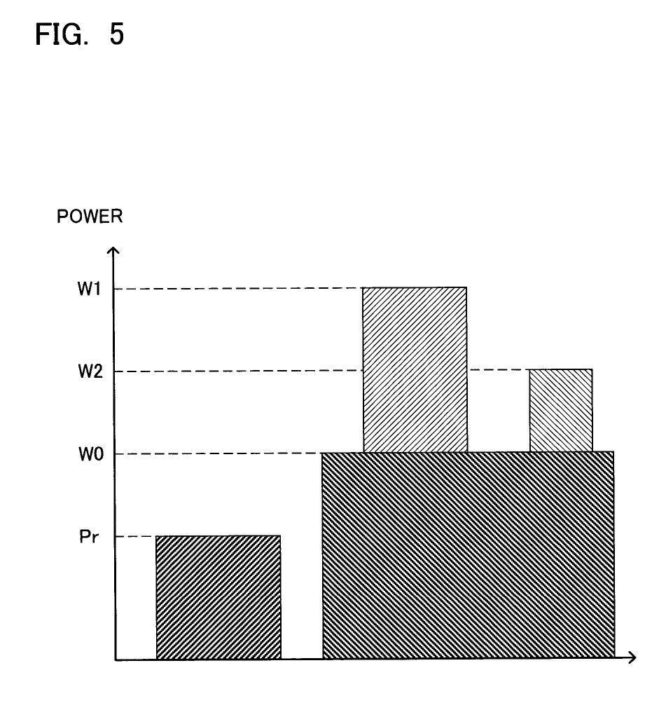

The LD controller 52 is comprised of four D/A (Digital/Analog) converters for outputs 530, 532, 534, 536 and registers 506, 508, 510 and 512 connected thereto. The maximum voltage levels of PrDAC 530, W0DAC 532, W1DAC 534 and W2DAC 536 are Pr, W0, W1 and W2 respectively, as shown in FIG. 5.

For example, PrDAC 530 is used for the output of read power, W0DAC 532 is used for the output of erase power, and W0DAC 532 and W1DAC 534 for the output of write power. W2DAC 536 along with W0DAC 532 output write initial power during write.

The LD driver 50 adds the output of the four DACs 530-534, converts it into drive current, and drives the laser diode 22. There may be only one DAC for output. With this configuration, however, the maximum voltage of each DAC can be decreased, drive voltage can be decreased, and power consumption can be decreased.

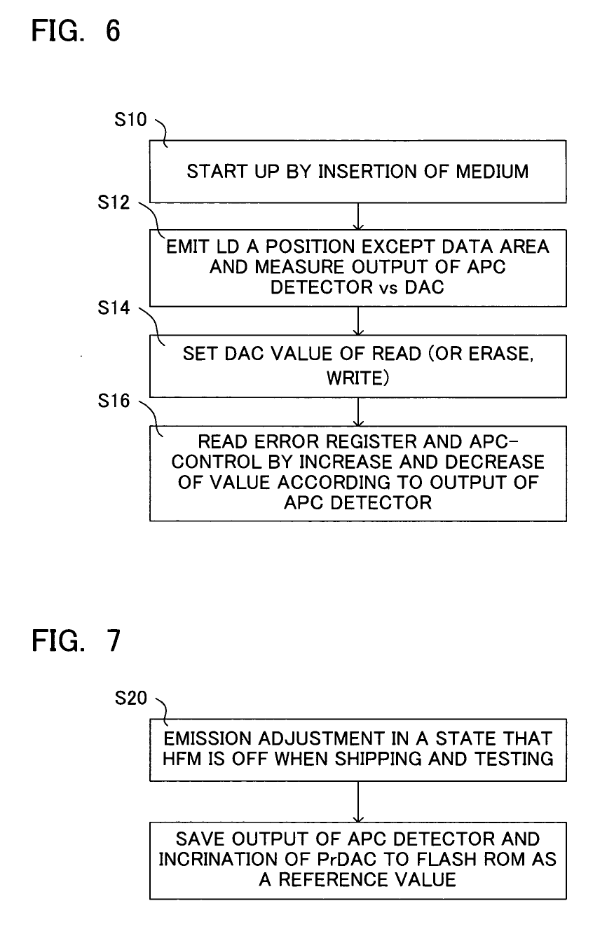

Now the APC processing of the MPU 70 using the LD controller 52 will be described with reference to FIG. 6.

(S10) The MPU 70 receives the detection of the insertion of the medium (MO disk) 10, and starts up the spindle motor 42.

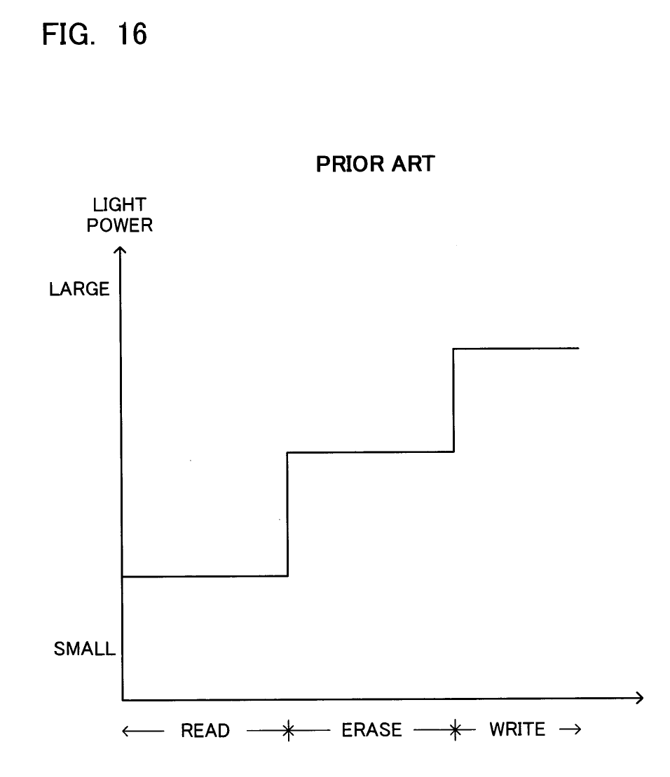

(S12) The MPU 70 moves the optical pickup 20 to a position other than the data area of the medium 10. For example, the most inner track area of the medium 10 is comprised of a mirror face, and is outside the data area. The MPU 70 operates DAC 530-536 via the registers 506-512, and allows the laser diode 22 to emit. The MPU 70 allows the laser diode 22 to emit with a plurality of DAC values, and reads the output level of the APC detector 26 at this time via the A/D converter 514 and register 500. By this, the MPU 70 measures the relationship of the DAC vs. the detection output of the APC detector, shown in FIG. 15, using the plurality of DAC values and the output level (power). Here the power on the storage medium and the detection output of the APC detector becomes a predetermined ratio. Therefore this relationship is given by the following expression, where “a” is the inclination, and “b” is the threshold value.

Detection output of APC detector=(DAC*a)+b

(S14) And read, erase and write operations become possible. When the MPU 70 receives a read or write (erase write) command, the MPU 70 sets the reference value REF of read, write or erase in the register 502 according to FIG. 16, calculates the DAC values for obtaining the read power, erase power and write power according to the above mentioned relational expression, and sets the DAC values to the registers 506-512. As a result, the laser diode 22 emits by the output voltage of the DACs 530-536 via the LD driver 50.

(S16) Along with this emission, the current value according to the emission power is output from the APC detector 26, and the I-V conversion circuit 520 converts the detection circuit iPD, according to the light receiving quantity from the APC detector 26, into voltage, and the amplifier 524 amplifies the converted voltage. This amplified voltage is converted into a digital value by the A/D (Analog/Digital) conversion circuit 514, then the result is compared with the measurement voltage from the amplifier 524 by the comparator 526, and the error amount ERR is calculated. This error amount ERR is converted into a digital value by the A/D (Analog/Digital) conversion circuit 528, is then stored to the register 504, and is read to the MPU (Main Controller) 70. The MPU 70 calculates the APC control value (DAC value) using the above mentioned relational expression so that this error amount becomes zero, and updates the values of the registers 506-512.

In this way, the emission power of the objective lens 32 is automatically controlled to be constant in each level of read, erase and write.

[Abnormality Detection Processing of APC Detector]

Now the abnormality detection processing for detecting abnormal phenomena of the APC detector and to prevent data destruction in advance will be described. Essentially in the present invention, set values of the past are stored when the light emission adjustment and the APC (sequential setting of READ POWER) is operating, and the possibility of separation, deviation, contamination or deterioration of the APC detector is detected by comparing the set values of the past with the current set values. And four processing methods will be described below, where one of these may be selected or a plurality of processing methods may be combined and used.

(1) When the medium is loaded, the inclination of the relationship of the DAC value vs. the detection output of the APC detector is detected, and is compared with the inclination value which was stored during normal operation.

(2) The inclination of the DAC value vs. the detection output of the APC detector is calculated when the APC operation to set the target power is performed, and is compared with the inclination value stored during normal operation.

In the above method, the inclination of the relationship between the DAC value (drive instruction value) and the APC detector output is normally constant, and does not fluctuate very much even should a temperature change occur, but in this example the abnormality of the APC detector is detected before data is destroyed by increasing the threshold value.

(3) The difference of error amounts before APC processing is compared between the previous time and this time.

(4) The change of the quantity of the return light (FES or TES) from the medium is compared.

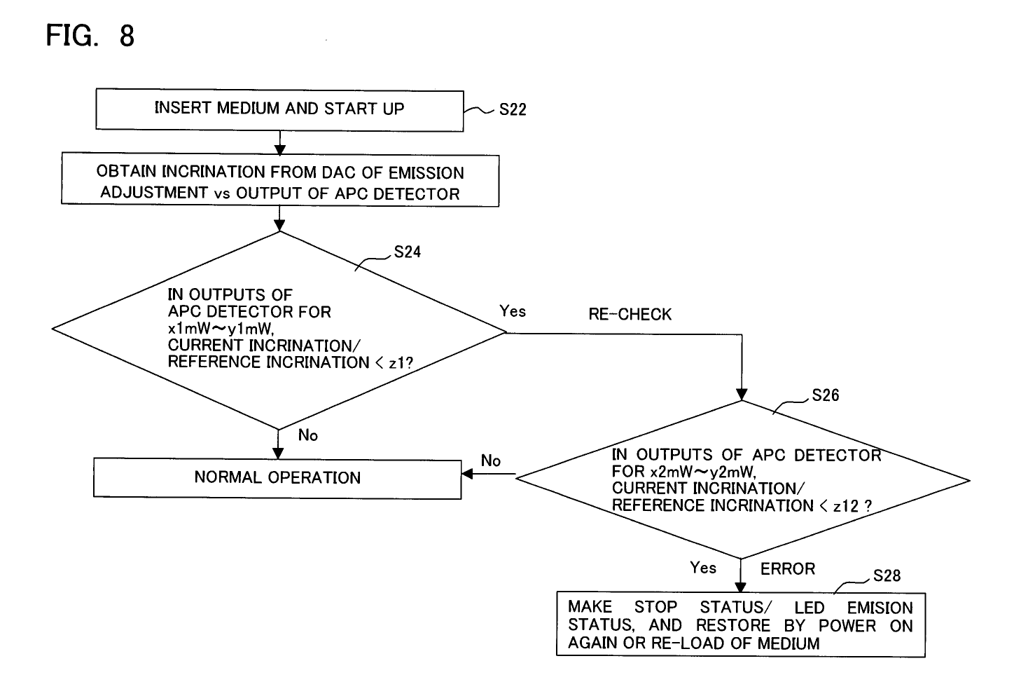

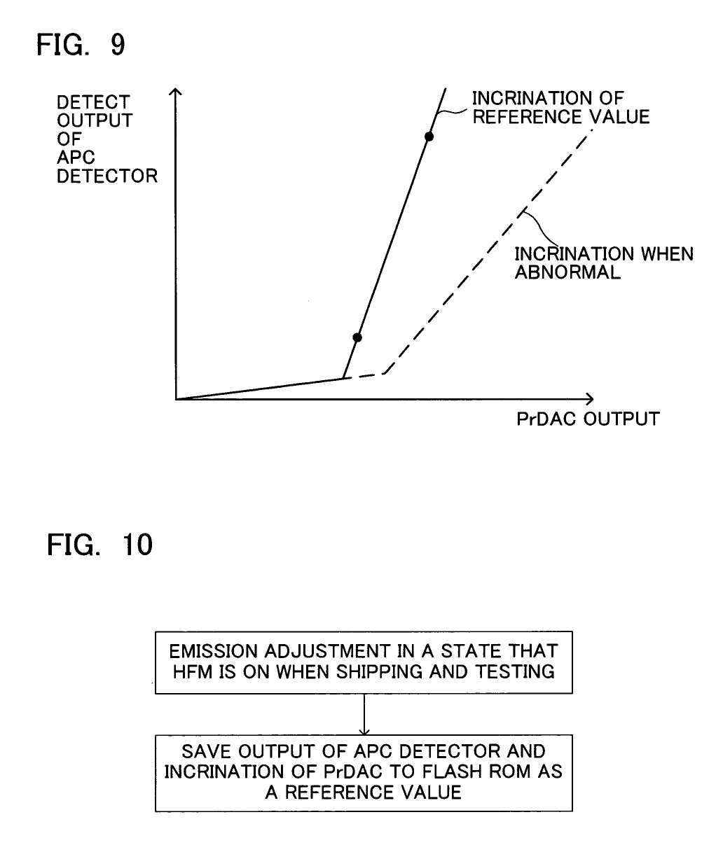

FIG. 7 and FIG. 8 are flow charts depicting the APC detector abnormality detection processing according to the first embodiment of the present invention, and FIG. 9 is a diagram depicting operation thereof, which corresponds to the above mentioned method (1).

(S20) As FIG. 7 shows, at factory shipment or at inspection of the apparatus, the high frequency modulation (HFM) for the laser diode 22 is turned OFF, and the emission adjustment described in step S12 in FIG. 6 is performed, and the inclination “a” of the relational expression between the PrDAC value and the detection output of the APC detector is saved in the flash memory of the apparatus, to be used as a reference value.

(S22) In FIG. 8, when the medium is inserted and started up, the relational expression of the DAC value vs. the detection output of the APC detector is calculated from the emission adjustment result in step S12 in FIG. 6, and the inclination “a1” is calculated by this relationship expression.

(S24) The inclination “a1” which is calculated at this time, and the inclination “a” at factory shipment, are compared. In other words, it is judged whether a1/a is the threshold value Z1 or less. If a1/a is not the threshold value Z1 or less, the inclinations have no difference, so normal operation is performed.

(S26) If “a1/a” is the threshold value Z1 or less, on the other hand, the APC detector may be defective, so a recheck is executed. In step S22, the inclination was calculated in the x1mW-y1mw range, but for a recheck, the emission adjustment is performed in a wider range, x2mW-y2mW, and the inclination of “a2” of the relational expression is calculated. The inclination “a2” calculated this time and the inclination “a” at factory shipment are compared. In other words, it is judged whether “a2/a” is the threshold Z12 or less. If “a2/a” is not the threshold value Z12 or less, the inclinations have little difference, so normal operation is performed.

(S28) If “a2/a” is the threshold value Z12 or less, on the other hand, it is judged that the APC detector is defective, operation stops, and the LED of the apparatus flashes. This status is recovered when power is turned ON again, or the medium is reloaded.

The relationship between the PrDAC value and the detection output of the APC detector changes depending on the temperature, as shown in FIG. 15, but the inclination changes little. As FIG. 9 shows, when the inclination during measurement largely changes with respect to the reference inclination, it can be regarded as an abnormality of the APC detector, and not because of a temperature change, so separation, deviation, deterioration or contamination of the APC detector can be identified. Since the abnormality of the APC detector is rechecked, the abnormality can be detected more accurately, also since an inspection is performed when the medium is loaded, data destruction can be prevented in advance.

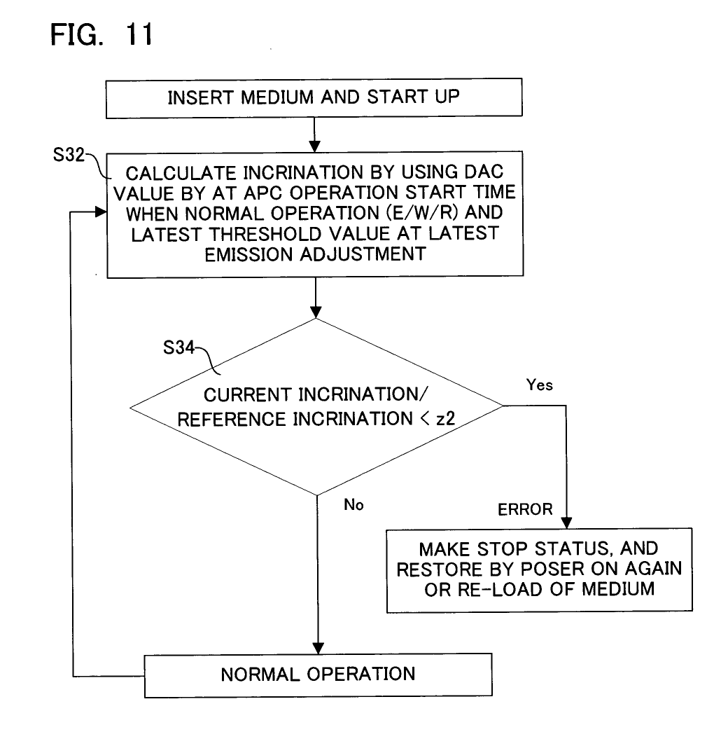

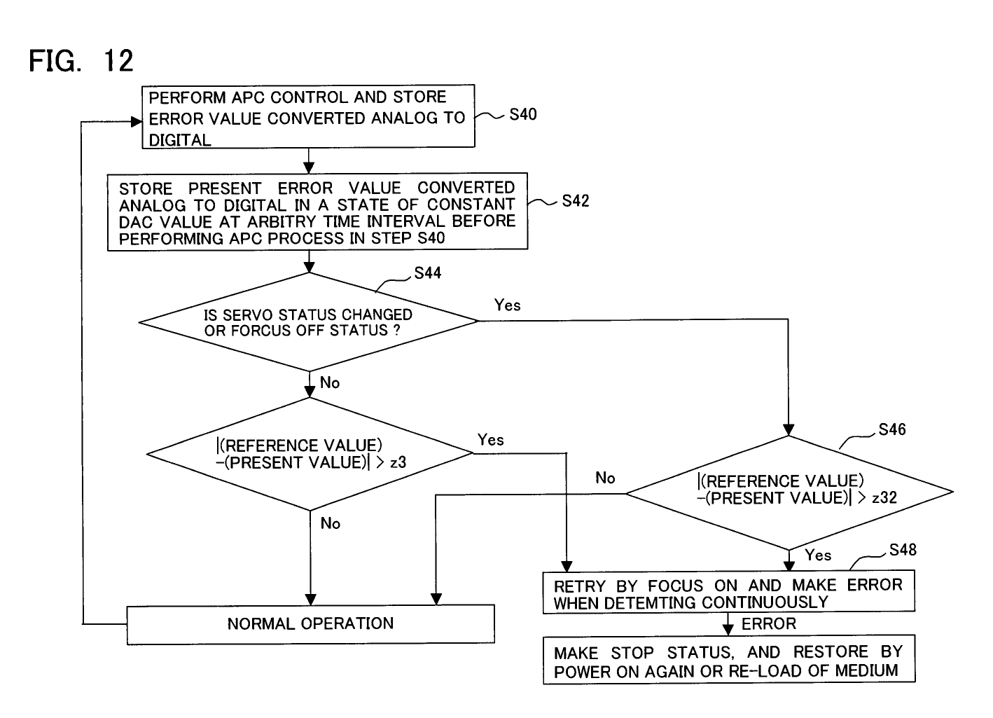

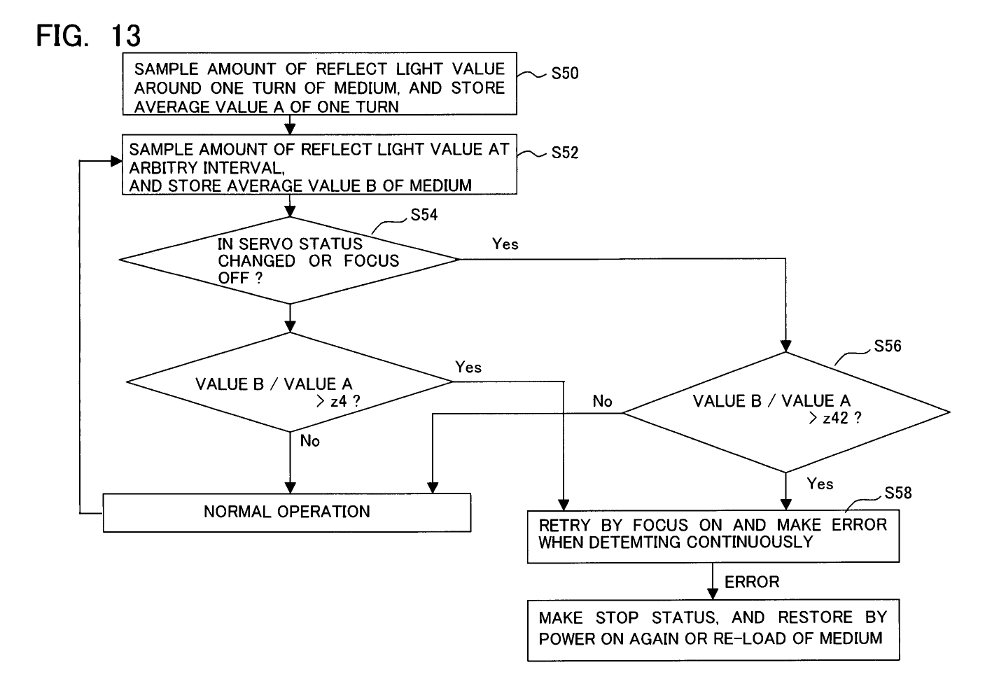

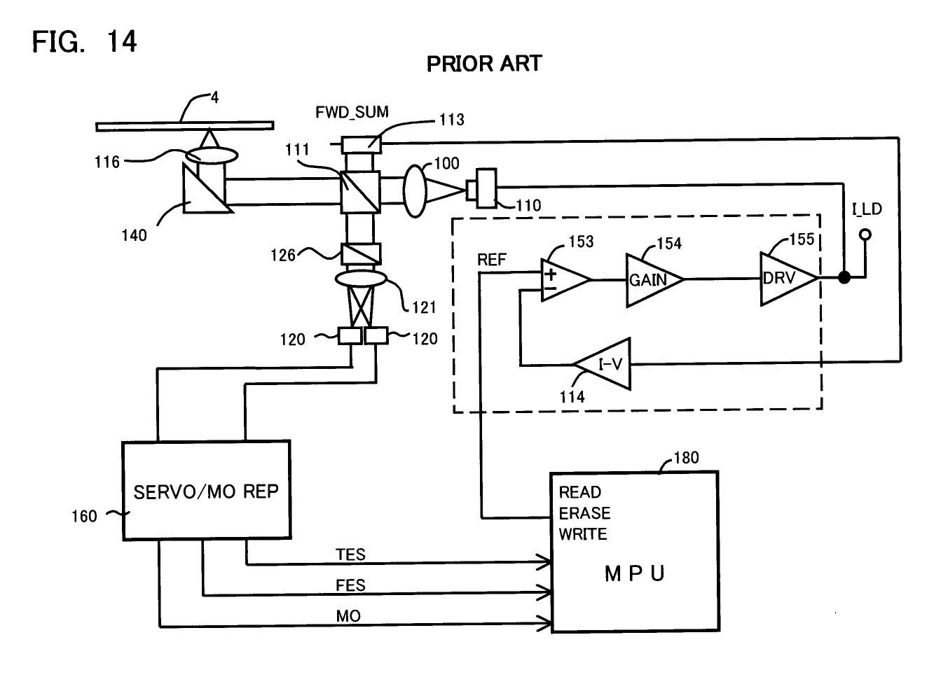

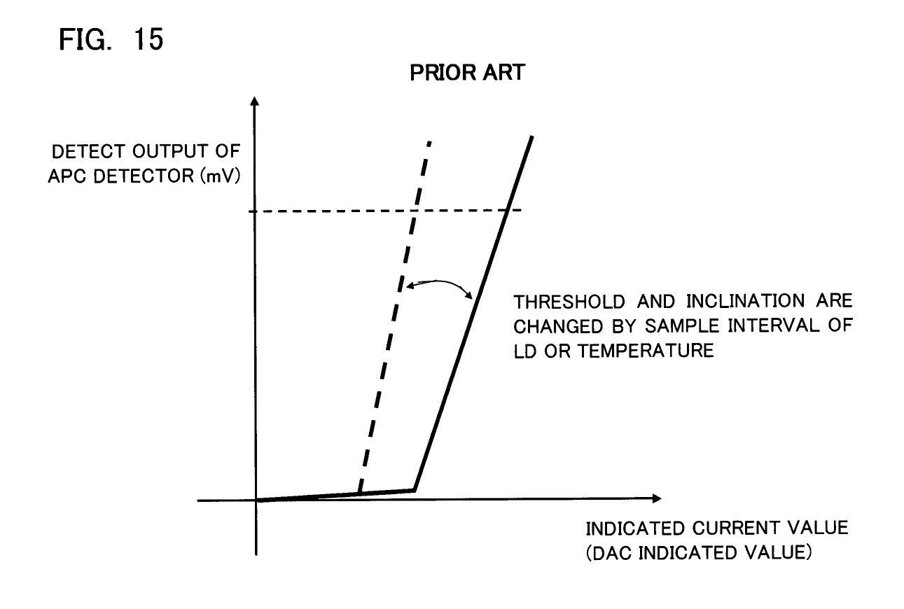

FIG. 10 and FIG. 11 are flow charts depicting the APC detector abnormality detection processing according to the second embodiment of the present invention, which corresponds to the detection method during APC processing described in (2).

(S30) AS FIG. 10 shows, at factory shipment or at inspection of the apparatus, the high frequency modulation (HFM) for the laser diode 22 is turned ON, and the emission adjustment described in step S12 in FIG. 6 is performed, and inclination “a′” of the relational expression between the PrDAC value and the detection output of the APC detector is saved in the flash memory of the apparatus to be used as a reference value.

(S32) In FIG. 11, during normal operation after the medium is inserted and started up, the relational expression of the DAC value vs. the detection output of the APC detector is calculated using the DAC value before start control where the APC control is executed, and the inclination ‘a3’ is calculated by this relational expression. The threshold value obtained in the latest emission adjustment result is used for data at the other point for this inclination calculation.

(S34) The inclination ‘a3’ which is calculated this time and the inclination ‘a′’ at factory shipment are compared. In other words, it is judged whether ‘a3/a′’ is the threshold value Z2 or less. If ‘a3/a′’ is not the threshold value Z2 or less, the inclinations have little difference, so normal operation is performed.

(S36) If ‘a3/a′’ is the threshold value Z2 or less, on the other hand, it is judged that the APC detector is defective, so operation stops. This status is recovered when the power is turned ON again or when the medium is reloaded.

In this example as well, the relationship between the PrDAC value and the detection output of the APC detector changes depending on the temperature, as shown in FIG. 15, but the inclination changes little. As FIG. 9 shows, when the inclination during measurement largely changes with respect to the reference inclination, it can be regarded as an abnormality of the APC detector, so separation, deviation, deterioration or contamination of the APC detector can be identified. Since the abnormality of the APC detector is detected when APC is performed, data destruction can be prevented in advance, even if the APC detector becomes unexpectedly abnormal during APC.

The third embodiment of the present invention will now be described. This embodiment is a method of comparing the difference of the error values ERR after A/D conversion at a constant DAC value. In other words, when the PrDAC is constant, the quantity of light from the APC detector does not suddenly change. So the error value ERR, which is obtained when current from the APC detector is A/D converted, is monitored each time, and when the difference of the result at a previous time and the result this time is great, it is judged that the APC detector is defective.

FIG. 12 is a flow chart depicting the APC detector abnormality detection processing according to the third embodiment of the present invention, which corresponds to the method described in (3).

(S40) At APC control after the medium is inserted, APC processing is performed to match with the target power, and the error value ERR after A/D conversion is stored as reference value ‘c’. Normally the error value ERR is zero or almost zero due to APC processing.

(S42) Before the next APC processing, the error value ERR after A/D conversion is read and stored in the state at a DAC value of the APC with an arbitrary time interval.

(S44) It is judged whether the focus servo status has changed or whether the focus servo is OFF, and if the focus servo status has not changed or if the focus servo is OFF, it is judged whether the absolute value of (reference value ‘c’-error value this time) is the threshold value Z3 or more. If the absolute value of (reference value ‘c’-error value this time) is not the threshold value Z3 or more, the error difference is small, so normal operation is performed, and processing returns to step S40.

(S46) If the focus servo status has changed or if the focus servo is OFF, a larger threshold value, Z32, is used. In other words, it is judged whether the absolute value (reference value ‘c’-error value this time) is the threshold value Z32 or more. If the absolute value of (reference value ‘c’-error value this time) is not the threshold value Z32 or more, the error difference is small, so normal operation is performed, and processing returns to step S40.

(S48) If the absolute value of (reference value ‘c’-error value this time) is the threshold value Z3 or more or Z32 or more, on the other hand, the APC detector may be defective, so it is rechecked. In other words, a retry is performed by turning the focus ON, and the measurement in step S42 and the comparison in step S44 or S46 are performed.

If the absolute value is still the threshold value Z3 or S32 or more, it is judged that the APC detector is defective, and operation stops. This status is recovered when the power is turned ON again or when the medium is reloaded.

Since the error after A/D conversion at a previous time and the error after A/D conversion this time are compared in a state of a constant DAC value, separation, deviation, deterioration or contamination of the APC detector can be identified. Also data destruction can be prevented in advance, even when the status of the detector suddenly changes during APC.

The fourth embodiment of the present invention will now be described. This embodiment checks the quantity of returned light from such a medium as FES and TES. In other words, the light returned from the medium contacts the servo detector 28 in FIG. 1, where the quantity of light can be detected. When the medium is loaded, the measured quantity value of returned light is stored, and when the quantity of the returned light becomes a certain top or bottom threshold value while APC control is performed at a target power, it is judged that the APC detector is defective.

(S50) After the medium is inserted, the laser diode 22 is emitted at read power, the quantity of returned light for one cycle of the medium (FES by the output of the servo detector 28 in FIG. 1) is sampled, and the average value ‘A’ of one cycle of the medium (reference value) is stored.

(S52) The laser diode 22 is emitted at the read power in the same way with an arbitrary time interval, the quantity of returned light for one cycle of the medium (FES by the output of the servo detector 28 in FIG. 1) is sampled, and the average value ‘B’ for one cycle of the medium is stored.

(S54) It is judged whether the focus servo status has changed or whether the focus servo is OFF, and if the focus servo status has not changed or if the focus servo is OFF, it is judged whether the average value ‘B’/reference value ‘A’ this time is the threshold value Z4 or more. If the average value ‘B’/reference value ‘A’ is not the threshold value Z4 or more, the error of the quantity of returned light is small, so normal operation is performed, and processing returns to step S52.

(S56) If the focus servo status has changed or if the focus servo is OFF, the larger threshold value Z42 is used. In other words, it is judged whether the average value ‘B’/reference value ‘A’ is the threshold value Z42 or more. If the average value ‘B’/reference value ‘A’ is not the threshold value Z42 or more, the error is small, so normal operation is performed, and processing returns to step S52.

(S58) If the average value ‘B’/reference value ‘A’ is the threshold value Z4 or Z42 or more, on the other hand, the APC detector may be defective, so it is rechecked. In other words, a retry is performed by turning the focus ON, and the measurement in step S52 and the comparison in step S54 or S56 are performed. If the average value ‘B’/reference value ‘A’ is still the threshold value Z4 or Z42 or more, it is judged that the APC detector is defective, and operation stops. This status is recovered when the power is turned ON again or when the medium is reloaded.

In this way, if the APC detector is defective, the emission power of the laser diode increases by APC control, and this can be detected by the quantity of the returned light. By taking an average value for one cycle of the medium, the emission power can be monitored without. depending on other factors. Regarding the average value of the quantity of returned light after the medium is inserted as a reference value, the reference value is compared with the average value of the quantity of returned light with an arbitrary interval, so separation, deviation, deterioration or contamination of the APC detector can be identified.

[Other Embodiments]

In the above described example, the focus error signal is detected by an astigmatism method, the track error signal is detected by a push-pull method, and the MO signal is detected from the differential detection signals of the polarization components, but the above mentioned optical system is used for an example of the present invention, and there were no problems even if the focusing error detection method is a knife edge method or a spot size position detection method. Also there were no problems even if the tracking error detection method is a three-beam method or a phase difference method.

The magneto-optical disk drive which performs recording, regeneration and erasing has been described, but the present invention can be applied to other optical disk drives which perform recording, regeneration and erasing (e.g. DVD-RW, CD-RW). The present invention can also be applied to an overwrite type magneto-optical disk drive and an optical disk drive which performs recording and regeneration. The present invention can also be applied to a magnetic modulation writing type magneto-optical disk drive. And the recording medium is not limited to a circular disk, but may be a card type.

The present invention has been described with the embodiments, but various modifications are possible within the scope of the essential character of the present invention, which shall not be excluded from the technical scope of the present invention.

In the present invention, the relationship between the drive instruction amount for emitting the light source and the detection output of the APC detector is measured, and the inclination thereof is compared with the inclination during normal time, so data destruction due to separation, deviation, contamination or deterioration of the APC detector can be prevented. Also the error values before and after APC are compared, and the change of quantity of returned light during a predetermined period is detected, so data destruction due to separation, deviation, contamination or deterioration of the APC detector can be prevented.

What is claimed is:

1. An optical storage apparatus for writing and reading a storage medium using a laser beam, comprising:
a light source for emitting a laser beam onto said storage medium;
a servo control unit for performing follow up control of said laser beam onto said storage medium according to a reflected light from said storage medium;
an APC detector for monitoring the emission power of said light source; and
a control unit for calculating a drive instruction amount based on a detection output of said APC detector, and performs automatic power control of said light source according to said drive instruction amount, so that the emission power on said storage medium is maintained to be a write power during said writing, and the emission power on said storage medium is maintained to be a read power during said reading,
wherein said control unit measures a inclination of a relationship between said drive instruction amount and the detection output of said APC detector, and judges the abnormality of said APC detector by comparing the pre-measured inclination of the relationship between said drive instruction amount and the detection output of said APC detector with said measured inclination.

2. The optical storage apparatus according to claim 1, wherein said control unit measures the detection output of said APC detector when said light source is driven with said drive instruction amount, and measures the inclination of the relationship between said drive instruction amount and said detection output.

3. The optical storage apparatus according to claim 1, wherein said control unit measures the inclination of the relationship between said drive instruction amount and the detection output of said APC detector when loading of said storage medium.

4. The optical storage apparatus according to claim 1, wherein said control unit judges the abnormality of said APC detector by comparing a value obtained by dividing said measured inclination by a pre-measured inclination with the threshold value.

5. The optical storage apparatus according, to claim 1, wherein said control unit performs said automatic power control with an arbitrary time interval, and measures the inclination of the relationship between said drive instruction amount and the detection output of said APC detector from said drive instruction amount at the start of said automatic power control.

6. An optical storage apparatus for writing and reading a storage medium using a laser beam, comprising:
a light source for emitting a laser beam onto said storage medium;
a servo control unit for performing follow up control of said laser beam onto said storage medium based on the reflected light from said storage medium; and
a control unit for calculating a drive instruction amount according to the error value between the detection output of said APC detector and the reference value, and performing automatic power control of said light source according to said drive instruction amount, so that the emission power on said storage medium is maintained to be a write power during said writing, and the emission power on said storage medium is maintained to be a read power during said reading,
wherein said control unit performs said automatic power control with an arbitrary time interval, and judges the abnormality of said APC detector by measuring said error values for a plurality of times and comparing said error values measured for the plurality of times in a state with said drive instruction amount fixed.

7. The optical storage apparatus according to claim 6, wherein said control unit judges the abnormality of said APC detector by comparing the difference of said error values measured for the plurality of times with the threshold value.

8. An optical storage apparatus for writing and reading a storage medium using a laser beam, comprising:
a light source for emitting a laser beam onto said storage medium;
a servo control unit for detecting reflected light from said storage medium and performing follow up control of said laser beam onto said storage medium;
an APC detector for monitoring an emission power of said light source; and
a control unit for calculating a drive instruction amount based on the detection output of said APC detector and performing automatic power control of said light source according to said drive instruction value, so that the emission power on said storage medium is maintained to be a write power during said writing, and the emission power on said storage medium is maintained to be a read power during said reading,
wherein said control unit measures an average value of quantities of said reflected light during a predetermined period, and judges the abnormality of said APC detector by comparing the average value of the quantities of the reflected light with the pre-measured average value of the quantities of the reflected light.

9. The optical storage apparatus according to claim 8, wherein said control unit judges the abnormality of said APC detector by comparing the ratio between both said average values with the threshold value.

10. An abnormality detection method of a detector for emission control, comprising the steps of:
performing automatic power control of a light source which emits a laser beam for writing and reading a storage medium onto said storage medium according to a drive instruction amount calculated based on a detection output of an APC detector for monitoring the emission power of said light source, so that the emission power on said storage medium is maintained to be a write power during said writing, and the emission power on said storage medium is maintained to be a read power during said reading;
measuring an inclination of a relationship between said drive instruction amount and the detection output of said APC detector; and
judging the abnormality of said APC detector by comparing a pre-measured inclination of the relationship between said drive instruction amount and said detection output of said APC detector with said measured inclination.

11. The abnormality detection method of a detector for emission control according to claim 10, wherein said measurement step comprises a step of measuring the detection output of said APC detector when said light source is driven with said drive instruction amount, and a step of measuring the inclination of the relationship between said drive instruction amount and said detection output.

12. The abnormality detection method of a detector for emission control according to claim 10, wherein said measuring step comprises a step of measuring the inclination of the relationship between said drive instruction amount and the detection output of said APC detector when said storage medium is loaded.

13. The abnormality detection method of a detector for emission control according to claim 10, wherein said judgment step comprises a step of judging the abnormality of said APC detector by comparing a value obtained by dividing said measured inclination by a pre-measured inclination with the threshold value.

14. The abnormality detection method of a detector for emission control according to claim 10, wherein said measurement step comprises a step of performing said automatic power control with an arbitrary time interval, and a step of measuring the inclination of the relationship between said drive instruction amount and the detection output of said APC detector from said drive instruction amount at the start of said automatic power control.

15. An abnormality detection method of a detector for emission control, comprising:
a control step of performing automatic power control of a light source which emits a laser beam for writing and reading a storage medium onto said storage medium according to a drive instruction amount calculated based on an error value between a detection output of an APC detector for monitoring an emission power of said light source and a reference value, so that the emission power on said storage medium is maintained to be a write power during said writing, and the emission power on said storage medium is maintained to be a read power during said reading;
a step of performing said automatic power control with an arbitrary time interval and measuring said error values for a plurality of times in a state with said drive instruction amount fixed; and
a step of judging the abnormality of said APC detector by comparing the error values measured for the plurality of times.

16. The abnormality detection method of a detector for emission control according to claim 15, wherein said judgment step comprises a step of judging the abnormality of said APC detector by comparing a difference of error values measured for two or more times out of said plurality of times with the threshold value.

17. An abnormality detection method of a detector for emission control, comprising:
a control step of performing automatic power control of a light source which emits a laser beam for writing and reading a storage medium onto said storage medium according to a drive instruction amount calculated based on a detection output of an APC detector for monitoring an emission power of said light source, so that the emission power on said storage medium is maintained to be a write power during said writing, and the emission power on said storage medium is maintained to be a read power during said reading;
a step of measuring the average value of quantities of a reflected light from said storage medium during a predetermined period; and
a step of judging the abnormality of said APC detector by comparing said measured average value of the quantities of the reflected light with a pre-measured average value of the quantities of the reflected light.

18. The abnormality detection method of a detector for emission control according to claim 17, wherein said judgment step comprises a step of judging the abnormality of said APC detector by comparing the ratio of both said average values and the threshold value.
